(19) United States
(12) Patent Application Publication
(10) Pub. No.: US 2016/0167116 A1
(43) Pub. Date: Jun. 16, 2016

(54) SALT CORES AND GENERATIVE PRODUCTION METHODS FOR PRODUCING SALT CORES

(71) Applicant: EMIL MÜLLER GMBH, Wilhermsdorf (DE)

(72) Inventor: Thorsten HARTIG, Puschendorf (DE)

(21) Appl. No.: 14/906,765

(22) PCT Filed: Jul. 24, 2014
(86) PCT No.: PCT/EP2014/065932

§ 371 Date: Jan. 21, 2016

(30) Foreign Application Priority Data
Jul. 24, 2013 (DE) 102013214465.2

(51) Int. Cl. B22C 9/10; B22C 1/00

(52) U.S. Cl. CPC B22C 9/105; B22C 1/00; B33Y 10/00

(57) ABSTRACT

The invention relates to salt cores as cavity placeholders in castings, wherein the salt cores have a layered structure and can be produced by means of an additive manufacturing method, particularly by means of selective laser melting.

The invention relates to salt cores as cavity placeholders in castings and to additive manufacturing methods for producing such salt cores. In particular, the invention relates to salt cores that are produced by means of selective laser melting.

The preferred field of use for salt cores is all casting methods for light metals and nonferrous heavy metals and production methods for plastics and/or carbon-fiber- and glass-fiber-reinforced components. Therefore, in the context of this invention, the term “casting” should comprise not only metal castings but also in general all molded parts that are cast or molded with the help of cores. In particular, plastic molded parts, which are produced for example by means of injection molding, should likewise be comprised by this term.

In the case of many products produced by casting, it is necessary to produce cavities in the interior or undercuts in the exterior region. In the unpressurized methods, such as gravity casting, a core composed of consolidated sand or salt is positioned within the mold and overcast with metal melt.

In the case of pressurized casting methods, a main problem is that of producing a pressure-resistant core. This core must be both pressure-resistant and easy to remove after the solidification and cooling of the casting. Due to the high pressure on all sides, the cores are compressed to more or less of an extent in dependence on the porosity. This can lead to a shift of the cores in the casting or to the fracture of the cores.

Furthermore, the porosity present causes a rough surface in the casting, because the melt penetrates the surface of the core and reproduces the porosity of the core. Previously, this could not be completely prevented even by applying facings. In general, a surface of the contour that is as smooth as possible is desired after the cores have been rinsed out of the casting. This can be achieved by means of the cores according to the invention.

Pure melt-cast cores, which would enable smooth surfaces in the casting, have been in use in founding for decades. However, wide use is not possible because of the shrinkage of the melt-cast cores that occurs during the cooling in the mold. The shrinkage lies in the range of 3 to 8% and often leads to the formation of cracks in the case of cores with complex geometry. Because of this shrinkage problem, only cores having low complexity can be realized.

The production of sintered cores having complex geometries is not possible, and is possible only by means of downstream process steps.

The problem addressed by the invention is that of avoiding the mentioned disadvantages, particularly that of providing salt cores having complex geometries, particularly having undercuts, and providing a method for producing such cores. A further problem addressed by the invention is that of providing salt cores that have high surface quality without complex post-treatment.

This problem is solved by means of a salt core according to claim 1 and by means of a method for producing salt cores according to claim 8. Advantageous developments of the subject matter of the invention can be found in the dependent claims.

Accordingly, a salt core according to the invention for producing castings has a layered structure, wherein the layered structure consists of layers of melted and resolidified salt.

According to the invention, such a salt core having a layered structure is produced by means of an additive manufacturing method.

According to an especially preferred embodiment of the invention, the salt core is composed of water-soluble materials, substantially of water-soluble salt. This has the advantage that a complexly shaped core, for example having undercuts or cavities, can be removed from the casting without residue by rinsing said core out.

The salt core according to the invention and the method for production differ from salt cores known from the prior art in that the salt cores can be produced without the use of primary shaping tools.

According to a preferred variant of the method, a molding material or a molding material mixture is formed of a salt and optionally of additional salts and aggregates.

Especially preferably, the salt cores are produced by additive manufacturing methods, particularly by selectively melting salt crystals by means of a laser (selective laser melting).

According to a preferred embodiment of the invention, the salt core can be designed hollow. According to the invention, the term “hollow salt core” means that the core has a firm outer shell that defines the shape of the core. The interior of the core can be empty or filled with molding material not specifically consolidated.

Especially preferably, the salt core consists of a surface shell produced by selective laser melting having any thickness, while the inner molding material portion surrounded by the consolidated surface shell is not fused.

According to a particular embodiment, the salt core produced by laser melting can be coated with a water-soluble facing or infiltrated with a salt melt in order to close open pores that are close to the surface.

It was found that it is possible to insert and mount a multitude of functional parts or components, which are used to produce, for example, transmissions, drive elements, pumps, channels, or pipe systems, into a hollow molded body not only after the production of said hollow body. These functional parts or components can be inserted into a water-soluble salt core, which is then overcast with metal or plastic in a casting method. Thereafter, the water-soluble salt core is rinsed out and the functional parts are already present in the desired position and function in the hollow molded body.

Accordingly, such a salt core is distinguished by at least one component, particularly selected from gears, transmission parts, shaft elements, or drive elements, which the salt core contains in form-closed connection in such a way that no back-casting with melt and no flake formation occur when the component is overcast. The at least one component is largely surrounded by the salt core, and therefore in general only the shafts or shaft bearings protrude from the salt core or lie at the surface of the salt core.

According to a preferred embodiment, the molding material used is composed of highly pure salt, particularly having pharmaceutical quality. The salt cores according to the invention have an NaCl content of more than 99 wt %, preferably of more than 99.5 wt % NaCl.

High complexity of the mold/of the core can be realized by means of the construction in layers. Hollow structures can also be produced.

Some advantages of such a method are listed below:
Economical and biologically/ecologically harmless salts can be used for the selective laser melting of the salts.
The salts are melted by computer-controlled, selective heating by means of a laser, wherein thin, smooth salt layers result therefrom. The selective melting operation must be repeated for each newly applied molding material layer. The solidification of the salt leads to a connection between the individually applied salt layers.
No warping at the component arises due to the construction in layers and the local melting of the salts by means of a laser. Because only small regions are heated and melted, the volume contraction during solidification can be counteracted.
The porosity/gas permeability of the produced cores/molds can be set in a specific manner, because there is a high level of geometry freedom in the case of this method.
The cores can be removed in a simple manner and without residue, because the cores are composed exclusively of water-soluble components.
Outgassing of the cores does not occur during casting, because no binders are used.
Flexibility and speed in the case of small series and prototypes
No tool costs, except for the laser printer

A crystalline salt, which can have preferably a unimodal grain size distribution but also a bi- or multimodal grain size distribution, is used as a molding material. A bi- or multimodal grain size distribution can be advantageous with regard to especially tight packing of the crystals in the molding material. The porosity present in the salt cores according to the invention can thus be varied. The salt cores according to the invention have a residual porosity of less than 5%, preferably of less than 3%, and especially preferably of less than 1%, with respect to the total volume of the core, particularly if said salt cores have been produced by means of selective laser melting.

Important selection criteria for the salts to be used are the minimal toxicity thereof, the solubility, and the melting point. In order to obtain a low melting point, eutectic salt mixtures whose melting point is lower than the melting points of the individual salts are preferably used in the case of selective laser melting.

Chlorides, sulfates, phosphates, or nitrates of the alkali, alkaline-earth, or subgroup elements, or mixtures of said salts, particularly sodium chloride, potassium chloride, magnesium chloride, and/or potassium sulfate, magnesium sulfate, ammonium sulfate, or sodium sulfate can be used as salts.

According to an especially preferred embodiment, the molding material mixture comprises a composition of sodium sulfate and sodium chloride or of sodium carbonate and sodium chloride or a mixture of these three salts. These salts are nontoxic and economically sensible.

Preferably, a molten phase is produced from the molding material, wherein the molten phase is in particular an Na₂SO₄— and/or an Na₂CO₃— and/or an NaCl-comprising melt, and is in particular an Na₂SO₄—NaCl melt of eutectic composition or an Na₂CO₃—NaCl melt of eutectic composition.

A salt core according to this preferred embodiment of the invention therefore comprises or is composed of Na₂SO₄ and/or Na₂CO₃ and/or NaCl and in particular a eutectic mixture of Na₂SO₄—NaCl or a eutectic mixture of Na₂CO₃—NaCl.

A method according to the invention for producing such salt cores is distinguished in that the salt molds or salt cores are produced in layers, particularly by local melting of a molding material by means of a laser.

Furthermore, the method according to the invention is distinguished in that the molding material is a powdery, granular, or granulated salt or a mixture of salts, having round, irregularly shaped or angular, splintery crystals.

According to a preferred embodiment of the invention, the grain size of the crystalline salt lies in the range of 0.01 mm to 2 mm. Especially preferred grain size ranges lie between 0.01 and 0.29 mm, between 0.3 and 1.3 mm, and/or between 1.31 and 2.0 mm, wherein the first two fractions can be used as rather fine-grained salt and the last fraction can be used as rather coarse-grained salt in mixtures of multimodal composition.

The additively produced salt core can additionally be infiltrated with a water-soluble salt melt.

1-13. (canceled)

14. A salt core for producing castings, comprising a layered structure, the layered structure comprising layers of melted and resolidified salt.

15. The salt core according to claim 14, wherein the salt core is water-soluble.

16. The salt core according to claim 14, wherein the salt core has a residual porosity of less than 5% with respect to the total volume of the salt core.

17. The salt core according to claim 14, wherein the salt core comprises Na₂SO₄ and/or Na₂CO₃ and/or NaCl and in particular is composed of a eutectic mixture of Na₂SO₄—NaCl or a eutectic mixture of Na₂CO₃—NaCl.

18. The salt core according to claim 14, wherein the salt core according to the invention is composed of at least 99 wt % NaCl, preferably of more than 99.5 wt % NaCl.

19. The salt core according to claim 14, wherein the salt core has a firm outer shell.

20. The salt core according to claim 14, wherein the salt core comprises at least one component, in particular selected from gears, transmission parts, shaft elements, or drive elements, in form-closed connection, the at least one component being largely surrounded by the salt core so that no back-casting with melt and no flake formation occur when the component is overcast.

21. A method for producing a salt core according to claim 14, wherein the salt core is produced by means of an additive manufacturing method, particularly by means of selective laser melting.

22. The method according to claim 21. wherein the salt core is produced in layers, particularly by local melting of a molding material comprising salt by means of a laser.

23. The method according to claim 21, wherein a crystalline salt, preferably in a unimodal, a bimodal, or a muitimodal grain size distribution, is used as a molding material.

24. The method according to claim 21, wherein a molten phase is produced from the molding material.

25. The method according to claim 21, wherein at least one component, particularly selected from gears, transmission parts, shaft elements, or drive elements, is integrated into the salt core in form-closed connection in such a way that the at least one component is largely surrounded by the salt core so that no back-casting of the component with melt and no flake formation occur when the salt core is overcast.

26. The method according to claim 21, wherein the additively produced salt core is infiltrated with a water-soluble salt melt.

27. The method according to claim 21, wherein the molten phase comprises a salt selected from the group consisting of Na₂SO₄, Na₂CO₃ and NaCl

28. The method of claim 27, wherein the melt comprises a Na₂SO₄—NaCl melt of eutectic composition or an Na2CO3—NaCl melt of eutectic composition.
